(19) United States
(12) Patent Application Publication
(10) Pub. No.: US 2009/0210736 A1
(43) Pub. Date: Aug. 20, 2009

(54) Multi-function battery monitor system for vehicles

(76) Inventors: Lonnie Calvin Goff, Tempe, AZ (US); Michael Conley, Thousand Oaks, CA (US); Mark Eidson, Tempe, AZ (US)

Correspondence Address: Lonnie Goff, 1433 S. Mill Ave, Tempe, AZ, 85281, US

(21) Appl. No.: 12/070,793

(22) Filed: Feb. 20, 2008

(51) Int. Cl. G06F 11/30; G06F 1/26

(52) U.S. Cl. 713/340

(57) ABSTRACT

A multi-function computer system that gathers information relating to the operational state of a battery, calculates the health of the battery from the gathered information, provides the health and operational state of the battery to a vehicle operator and includes the means for supporting non-battery related functions.

### CROSS REFERENCE TO RELATED APPLICATIONS

Not Applicable

### FEDERALLY SPONSORED RESEARCH OR DEVELOPMENT

Not Applicable

### SEQUENCE LISTING, TABLE OR COMPUTER PROGRAM LISTING ON CD

Not Applicable

### BACKGROUND OF THE INVENTION

1. Field of Invention

The present invention relates to the field of computers. In particular it relates to the gathering and analysis of information that describes the health and operational state of batteries, the transfer of this information to an operator and to the economy realized by combining battery monitoring functions with non-related functions.

2. Prior Art

All batteries fail. In particular the automobile battery is particularly onerous. Automobile manufactures currently provide only the real-time state of the car's charging system (alternator) when the engine is running. The battery is only one component of this system. This system warns the motorist when there is a problem with the charging system by using a dash mounted voltmeter, ammeter or more commonly a warning lamp which is often referred to as the “idiot light”. This information should not be confused nor equated with the operating state or the overall health of the battery, itself. Typically a loose or broken alternator belt causes the warning lamp to come on.

Automobile battery malfunctions are seldom caused by a factory defect; driving habits are the more common culprits. The heavy auxiliary power drawn during a short distance driven never allows the periodic fully saturated charge that is so important for the longevity of a lead acid battery.

A German manufacturer of luxury cars reveals that of every 400 car batteries returned under warranty, 200 are working well and have no problem. Low charge and acid stratification are the most common causes of the apparent failure. The car manufacturer says that the problem is more common on large luxury cars offering power-hungry auxiliary options than on the more basic models.

It would be important to know when the health of a battery has deteriorated sufficiently to signal that a failure is impending. In some situations this information could be life-saving such as when operating in combat zones or under severe weather conditions. It would also be important to know that by merely changing the usage pattern of a vehicle such as combining multiple shopping trips into a single extended trip or by knowing when to apply an external battery charger that the life of the battery would be extended and impending failures avoided.

A system by which the driver of an internal combustion engine automobile, or the skipper of a boat or the driver of a hybrid vehicle or the operator in a control center such as a nuclear facility or the driver of an electric vehicle can know both the operating state and the general health of their batteries would therefore be desirable.

This invention is cognizant of the economy and facilitation achieved by combining the battery monitor function with non-related systems such as automobile sound systems, tire pressure systems, global positioning systems and alarm systems. All of these different systems contain microprocessors which are typically underutilized. In the $257 billion dollar automotive aftermarket, these systems are sold and installed as single function devices with separate enclosures. Also, given the power requirements of today's microprocessor technology it is not feasible to build self-powered devices. The installation of these systems therefore becomes problematic in that they typically must be wired into the vehicle's wiring harness in order to utilize the vehicle's primary power source. This usually requires the services of a professional installer or skilled technician. Therefore, in order to both economize manufacturing costs and installation costs the combining of battery monitoring with non-battery related functionality in the same enclosure is therefore deemed desirable.

### BRIEF SUMMARY OF THE INVENTION

Per one embodiment, the present invention provides a computer based controller installed proximate to a battery and contains facilities for attaching to the battery's terminals. This computer system also includes facilities for measuring time and some combination of battery voltage, battery current and battery temperature. This computer system also includes storage facilities for retaining a history of these measurements. In addition, this computer system contains algorithms for diagnosing the general health of the battery based upon the active and historical measurements. Finally this computer system transmits the active state and the health of the battery to a second computer system that either makes this information available to an operator or passes this information on to yet another computer. This second computer system can be a dedicated system whose sole purpose is to display the battery information or more desirably it can be a multi-function system that, in addition to supporting battery information, performs other non-battery related functions.

Per another embodiment, the present invention takes advantage of any existing systems which are installed proximate to a battery and contains facilities for attaching to the battery's terminals. An example would be an automobile alarm system which installs under the hood of the car and receives it power through a fused wire attached to the car battery. This embodiment includes a computer system built inside the existing alarm module that measures time and some combination of battery voltage, battery current and battery temperature. This computer system also includes storage facilities for retaining a history of these measurements. In addition, this computer system contains algorithms for diagnosing the general health of the battery based upon the active and historical measurements. Finally this computer system makes the active state and the health of the battery known to the operator by either transmitting this information to a second computer system which contains an operator interface or signals this information in another manner such as the blinking of variously colored light-emitting-diodes or lamps that are installed in the driver's compartment.

### BRIEF DESCRIPTION OF THE DRAWINGS

FIG. 1A is a block diagram of a dual computer system according to an embodiment of the invention that is dedicated to monitoring the state of the battery, calculating its health and making this information available to a remote operator.

FIG. 1B is a flow chart illustrating the steps taken by the structural illustration of FIG. 1A when it collects battery data, calculates battery health and sends this information.

FIG. 1C is a flow chart illustrating the steps taken by the structural illustration of FIG. 1A when it receives and displays battery data and battery health.

FIG. 2A is a block diagram of a dual computer system according to an embodiment of the invention that, in addition to monitoring the state of the battery, calculating its health and making this information available to a remote operator also supports a non-battery related function.

FIG. 2B is a flow chart illustrating the steps taken by the structural illustration of FIG. 2A when it receives and displays battery data, battery health and non-battery related data.

FIG. 3 is a block diagram of a single computer system according to an embodiment of the invention that attaches locally to a battery, monitors its state, calculates its health and makes this information available to a remote operator through attachment to remote lamps.

### DETAILED DESCRIPTION OF THE INVENTION

The following descriptions are provided to enable any person skilled in the art to make and use the invention and is provided in the context of three particular embodiments. Various modifications to the embodiments are possible and the generic principles defined herein may be applied to these and other embodiments without departing from the spirit and scope of the invention. Thus the invention is not intended to be limited to the embodiments shown but is to be accorded the widest scope consistent with the principles, features and teachings disclosed herein.

In accordance with one embodiment, the present invention provides two dedicated computer systems. One dedicated computer system gathers the voltage, current and temperature from a locally attached battery. This information is both saved in the computer system's memory and is used to calculated the health of the battery. All of this information is also transmitted to the second computer system. The second computer system is dedicated to displaying the received battery information on its console.

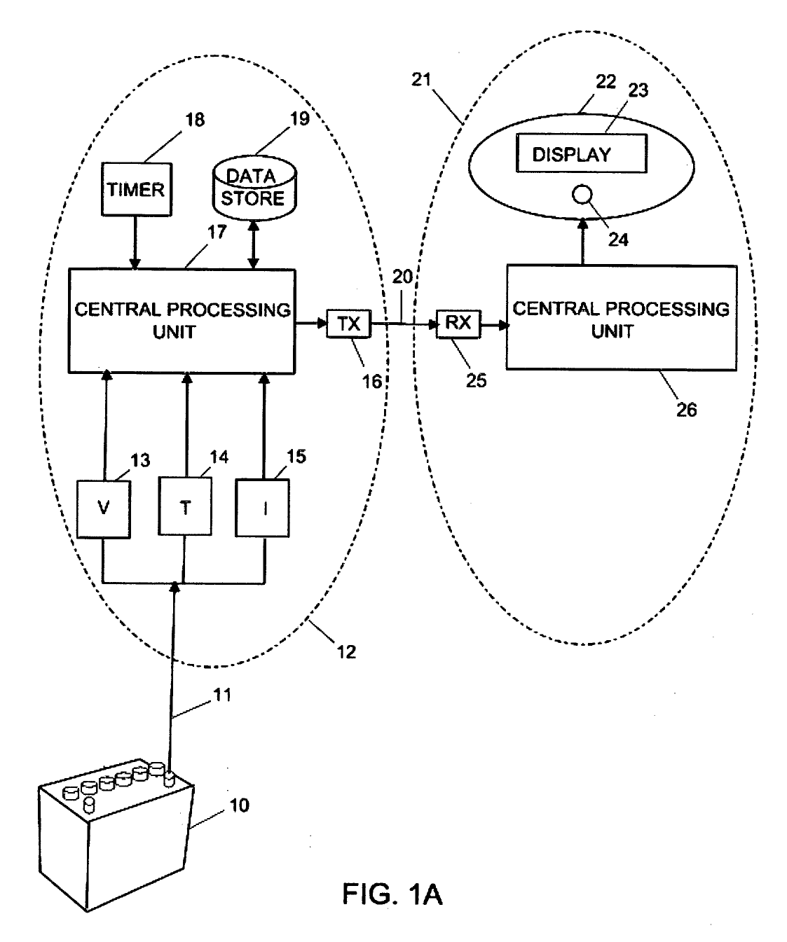

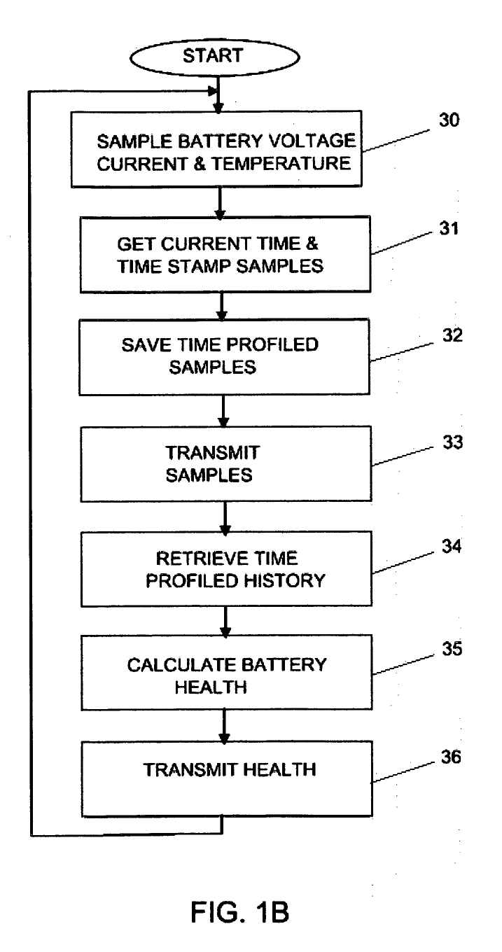

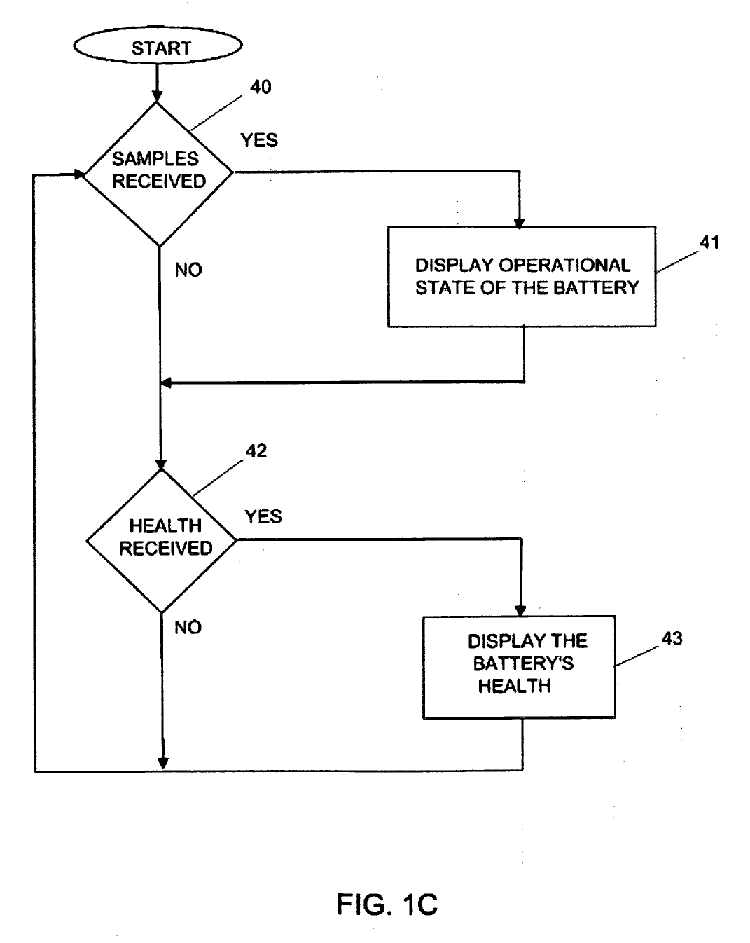

FIG. 1A is a block diagram illustrating a dual computer system in accordance with an embodiment of the present invention. Computer system 12 locally attaches to the non-grounded terminal of battery 10 through wire 11. (The return path from computer system 12 to the grounded terminal of battery 10 has not been illustrated but is apparent to anyone skilled in the art.) Wire 11 attaches to voltage sensor 13, temperature sensor 14 and current sensor 15. To be effective, temperature sensor 14 must be attached either inside or in the near proximity of battery 10. The central processing unit 17 enables sampling to be performed in voltage sensor 13, temperature sensor 14 and current sensor 15. The samples are retrieved by central processing unit 17, and in conjunction with timer 18, time stamped and saved in data store 19, The samples are also transferred via transceiver 16 to computer system 21 using transmission media 20. Transmission media 20 is any media that is suitable for the transfer of digital information such as wired media, wireless media and optical media. Central processing unit 26 receives the samples via transceiver 25 and displays the sample information on display 23 of console 22 when so directed by the console control 24. By means specified in various software algorithms computer system 12 renders a profile of the current health of the battery. These algorithms make use of the history contained in data store 19. This history is made rich by a time profile whose creation by central processing unit 17 is facilitated by timer 18 and included with the voltage, current and temperature samples as saved in data store 19. The time profile permits the means by which the central processing unit 17 can, as an example, estimate driving time in automobiles based upon periodic changes in battery voltage, battery current and battery temperature. This in turn relates directly to the health and well being of the battery. The calculated health report is transferred via transceiver 16 to computer system 21 using transmission media 20. Central processing unit 26 receives the health report via transceiver 25 and displays the health information on display 23 of console 22 when so directed by the console control 24. Under those conditions wherein bad health is reported, central processing unit 26 overrides console control 24 and causes the bad health information to be shown immediately and unconditionally to the operator on display 23.

FIG. 1B is a flowchart illustrating the steps taken by computer system 12 (FIG. 1A) in order to gather, analyze and transfer the current operating state and the rendered health of a battery. In step 30 the current state of the battery is sampled. In step 31 the current time is obtained. In step 32 the current time is added to the battery samples and saved. The current operational state of the battery as defined by the battery samples taken in step 30 are transmitted in step 33 to a remote console. In step 34 the history of the time profiled battery samples is made available in step 35 to a library of computer algorithms which provide the means by which the health of the battery is calculated. In step 36 the calculated health of the battery is transmitted to a remote console.

FIG. 1C is a flowchart illustrating the steps taken by computer system 21 (FIG. 1A) in order to display the battery information sent by computer system 12 (FIG. 1A). In step 40 a check is made to determine if battery samples which represent the current state of the battery have been received. If no samples have been received, program control is directed to step 42. If samples are available, this information is displayed on the operator's console in step 41. Program control then is directed to step 42 where a check is made to see if the health of the battery has been received. If a health report has not been received program control is directed to step 40. If a health report has been received, this information is displayed on the operator's console in step 43. Program control is then directed to step 40.

In accordance with another embodiment, the present invention provides two computer systems. One is a dedicated computer system that gathers the voltage, current and temperature from a locally attached battery. This information is both saved in the computer system's memory and is used to calculated the health of the battery. All of this information is also transmitted to the second computer system. The second computer system is a multifunction system in that it displays the received battery information on its console and also processes information from an unrelated source. In this embodiment, the unrelated source is a tire pressure system that uses a wireless connection to provide such information.

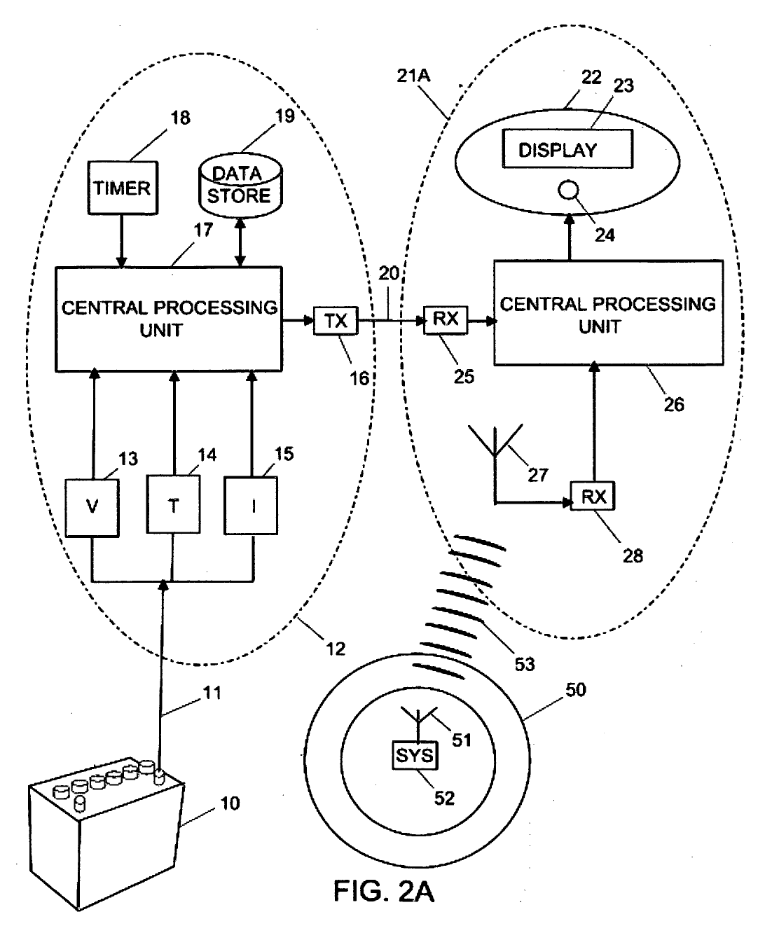

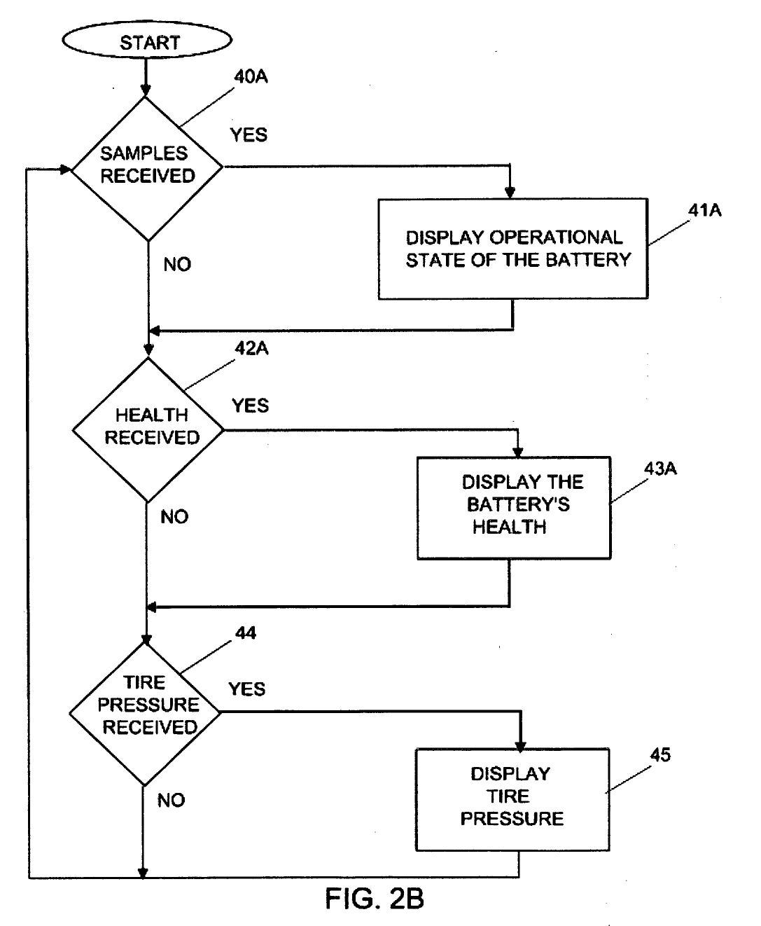

FIG. 2A is a block diagram illustrating a dual computer system in accordance with another embodiment of the present invention. Computer system 12 is the same device described in FIG. 1A. It gathers, analyzes and transfers battery information to computer system 21A. Central processing unit 26 receives the battery information via transceiver 25 and displays this information on display 23 of console 22 when so directed by console control 24. (Central processing 26 has the means to override console control 24 and immediately display battery information of a critical nature.) Computer system 21A also receives tire pressure information from computer system 52 mounted inside tire 50. This wireless information 53 is transmitted by computer system 52 using antenna 51. This wireless information 53 is received by antenna 27 and made available to central processing unit 26 by wireless transceiver 28. It is displayed on display 23 of console 22 when so directed by console control 24.

FIG. 2B is a flowchart illustrating the steps taken by computer system 21A (FIG. 2A) in order to display both the battery information sent by computer system 12 (FIG. 2A) and the tire pressure information sent by computer system 52 (FIG. 2A). In step 40A a check is made to determine if battery samples which represent the current state of the battery have been received. If no samples have been received, program control is directed to step 42A. If samples are available, this information is displayed on the operator's console in step 41A. Program control then is directed to step 42A where a check is made to see if the health of the battery has been received. If a health report has not been received program control is directed to step 44. If a health report has been received, this information is displayed on the operator's console in step 43A. Program control is then directed to step 44 where a check is made to see if tire pressure information has been received. If tire pressure information has not been received program control is directed to step 40A. If tire pressure information has been received, this information is displayed on the operator's console in step 45. Program control is then directed to step 40A.

In accordance with still yet another embodiment, the present invention provides a single computer system that gathers the voltage, current and temperature from a locally attached battery. This information is both saved in the computer system's memory and is used to calculate the health of the battery. This system also includes the means by which remote lamps can be controlled.

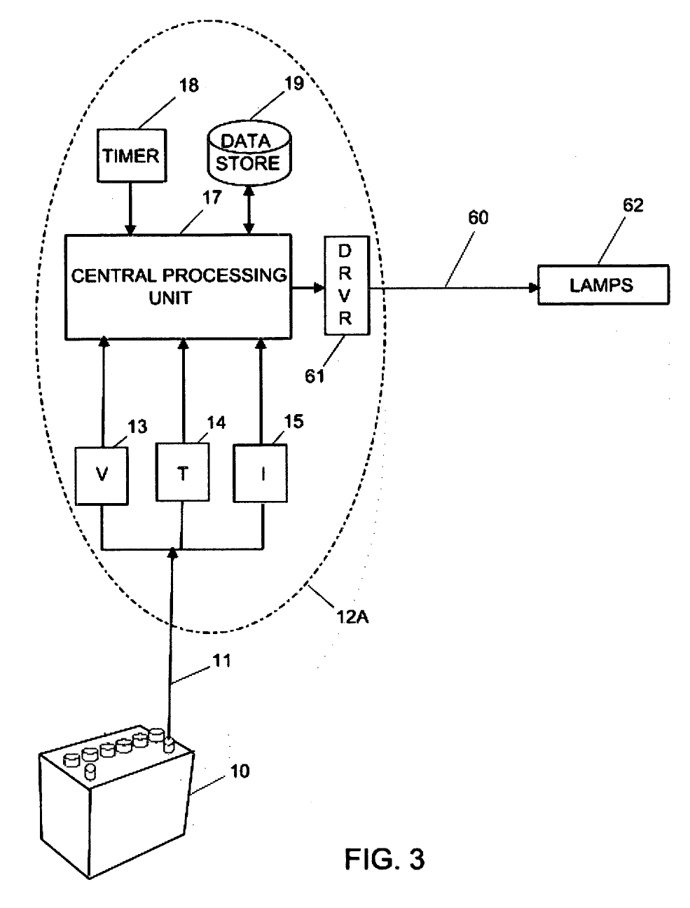

FIG. 3 is a block diagram illustrating a single computer system in accordance with another embodiment of the present invention. Computer system 12A (FIG. 3) is similar to computer system 12 described in FIG. 1A. It gathers, analyzes and stores battery 10 information. It uses this stored information 19 to calculate the health of the attached battery. The health and operational state of the battery are displayed in a remote location by using driver circuit 61 to send information across wire 60 to lamps 62 that are in the proximity of an operator.

The foregoing descriptions of multiple embodiments of the present invention are by way of example, only, and other variations and modifications of the above-described embodiments are possible in light of the foregoing teachings. In particular FIG. 2A illustrates the dual function computer system 21A where battery and tire pressure information are combined. Other examples, such as a global positioning system, could as well be included in computer system 21A. The important teaching of this example is that manufacturing costs and installation expenses are reduced by combining functionality inside the same unit.

Also of note is the single function, single computing system architecture of the structural block diagram of FIG. 3. This embodiment is structurally similar to that of an automobile alarm system. It would therefore be feasible and cost effective to add a vibration sensor (accelerometer) and a wireless controlled kill switch to computer system 12A (FIG. 3) in order to render a single unit that acts as both a theft deterrent and a early battery-failure warning system.

What is claimed is:

1. A dual computer system comprising of one computer system whereby the means for gathering information relating to the operational state of a battery is included and whereby the means for transferring this information to the second computer system is included.

2. The dual computer system of claim 1 wherein the second computer system includes the means for notifying an operator of the operational state of the battery.

3. The dual computer system of claim 2 wherein battery voltage is included in the gathered information.

4. The dual computer system of claim 3 wherein battery current is included in the gathered information.

5. The dual computer system of claim 4 wherein battery temperature is included in the gathered information.

6. The dual computer system of claim 5 wherein the means for assessing the health of a battery is calculated from the gathered information.

7. The dual computer system of claim 6 wherein the means for providing non-battery related functionality is included.

8. The dual computer system of claim 7 wherein the means for providing tire pressure information is included.

9. The dual computer system of claim 7 wherein the means for supporting global positioning information is included.

10. The dual computer system of claim 7 wherein the means for supporting an audio system is included.

11. The dual computer system of claim 7 wherein the means for supporting a theft deterrent system is included.

12. A single computer system whereby the means for gathering information relating to the operational state of a battery is included and whereby the means for transferring this information to the vehicle operator is included.

13. The single computer system of claim 12 wherein battery voltage is included in the gathered information.

14. The single computer system of claim 13 wherein battery current is included in the gathered information.

15. The single computer system of claim 14 wherein battery temperature is included in the gathered information.

16. The single computer system of claim 15 wherein the means for assessing the health of a battery is calculated from the gathered information.

17. The single computer system of claim 16 wherein the means for providing non-battery related functionality is included.

18. The single computer system of claim 17 wherein the means for supporting a theft deterrent system is included.
